(19) United States
(12) Patent Application Publication
(10) Pub. No.: US 2021/0151304 A1
(43) Pub. Date: May 20, 2021

(54) SAMPLE ANALYSIS APPARATUS HAVING IMPROVED INPUT OPTICS AND COMPONENT ARRANGEMENT

(71) Applicant: ADAPTAS SOLUTIONS PTY LTD, Clyde, New South Wales (AU)

(72) Inventors: Russell Jurek, Clyde, New South Wales (AU); Kevin Hunter, Clyde, New South Wales (AU)

(21) Appl. No.: 17/046,952

(22) PCT Filed: Apr. 12, 2019
(86) PCT No.: PCT/AU2019/050333

§ 371 Date: Oct. 12, 2020

(30) Foreign Application Priority Data
Apr. 13, 2018 (AU) 2018901240

(51) Int. Cl. H01J 49/02; H01J 49/04; H01J 49/14; H01J 49/20

(52) U.S. Cl. CPC H01J 49/025; H01J 49/20; H01J 49/147; H01J 49/0422

(57) ABSTRACT

A sample analysis apparatus for scientific analytical equipment such as mass spectrometers. The sample analysis apparatus includes an ion source configured to generate an ion from a sample input into the particle detection apparatus, and an ion detector having an input configured to receive an ion generated from an ion source. The sample analysis apparatus is configured such that a contaminant comingling with an ion generated by the ion source and flowing in the same general direction as the ion, is inhibited or prevented from entering the detector input.

### FIELD OF THE INVENTION

The present invention relates to generally to components of scientific analytical equipment. More particularly, the invention relates to instruments such as mass spectrometers that rely on ion detectors and modifications thereto for extending the operational lifetime or otherwise improving performance.

### BACKGROUND TO THE INVENTION

In a mass spectrometer, the analyte is ionized to form a range of charged particles (ions). The resultant ions are then separated according to their mass-to-charge ratio, typically by acceleration and exposure to an electric or magnetic field. The separated signal ions impact on an ion detector surface to generate one or more secondary electrons. Results are displayed as a spectrum of the relative abundance of detected ions as a function of the mass-to-charge ratio.

In other applications the particle to be detected may not be an ion, and may be a neutral atom, a neutral molecule, or an electron. In any event, a detector surface is still provided upon which the particles impact.

The secondary electrons resulting from the impact of an input particle on the impact surface of a detector are typically amplified by an electron multiplier. Electron multipliers generally operate by way of secondary electron emission whereby the impact of a single or multiple particles on the multiplier impact surface causes single or (preferably) multiple electrons associated with atoms of the impact surface to be released.

One type of electron multiplier is known as a discrete-dynode electron multiplier. Such multipliers include a series of surfaces called dynodes, with each dynode in the series set to increasingly more positive voltage. Each dynode is capable of emitting one or more electrons upon impact from secondary electrons emitted from previous dynodes, thereby amplifying the input signal.

Another type of electron multiplier operates using a single continuous dynode. In these versions, the resistive material of the continuous dynode itself is used as a voltage divider to distribute voltage along the length of the emissive surface.

A simple example of a continuous dynode multiplier is a channel electron multiplier (CEM). This type of multiplier consists of a single tube of resistive material having a treated surface. The tube is normally curved along its long axis to mitigate ion feedback. The term “bullet detector” is sometimes used in the art.

A CEM may have multiple tubes in combination to form an arrangement often referred to as a multi-channel CEM. The tubes are often twisted about each other, rather than simply curved as in the case of the single tube version discussed immediately above.

A further type of electron multiplier is the magneTOF detector, being both a cross-field detector and a continuous dynode detector.

An additional type of electron multiplier is a cross-field detector. A combination of electric fields and magnetic fields perpendicular to the motions of ions and electrons are used to control the motions of charged particles. This type of detector is typically implemented as a discrete or continuous dynode detector.

A detector may comprise a microchannel plate detector, being a planar component used for detection of single particles (electrons, ions and neutrons). It is closely related to an electron multiplier, as both intensify single particles by the multiplication of electrons via secondary emission. However, because a microchannel plate detector has many separate channels, it can additionally provide spatial resolution.

It is a problem in the art that the performance of electron emission-based detectors degrade over time. It is thought that secondary electron emission reduces over time causing the gain of the electron multiplier to decrease. To compensate for this process, the operating voltage applied to the multiplier must be periodically increased to maintain the required multiplier gain. Ultimately, however, the multiplier will require replacement. It is noted that detector gain may be negatively affected both acutely and chronically.

Prior artisans have addressed the problems of dynode ageing by increasing dynode surface area. The increase in surface area acts to distribute the work-load of the electron multiplication process over a larger area, effectively slowing the aging process and improving operating life and gain stability. This approach provides only modest increases in service life, and of course is limited by the size constraints of the detector unit with a mass spectrometry instrument.

A further problem in the art is that of internal ion feedback, this being particularly the case for microchannel plate detectors. As the number of electrons exponentially increases through the amplification means of the detector, adsorbed atoms can be ionized. These ions are then accelerated by the detector bias towards the detector input. Unless specific measures are taken these ions can have sufficient energy to release electrons as they collide with the channel wall. The collision initiates a second exponential increase in electrons. These “false” after-pulses not only interfere with an ion measurement, but may also lead to a permanent discharge and essentially destroy the detector over time.

It is an aspect of the present invention to overcome or ameliorate a problem of the prior art by providing a dynode-based detector or other electron emission-based detector having an extended service life, and/or improved performance. It is a further aspect to provide a useful alternative to the prior art.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

In a first aspect, but not necessarily the broadest aspect, the present invention provides a sample analysis apparatus comprising: an ion source configured to generate an ion from a sample input into the particle detection apparatus, and an ion detector having an input configured to receive an ion generated from an ion source, wherein the sample analysis apparatus is configured such that a contaminant comingling with an ion generated by the ion source and flowing in the same general direction as the ion, is inhibited or prevented from entering the detector input.

In one embodiment of the first aspect, the sample analysis apparatus comprises ion direction alteration means configured to alter the direction of an ion generated by the ion source and conveyed in a direction away from the ion source, the alteration in direction being sufficient so as to separate the ion from the contaminant or at least decrease the concentration of the contaminant in a space about the ion.

In one embodiment of the first aspect, the ion direction alteration means acts to deflect the path of an ion generated by the ion source and conveyed in a direction away from the ion source.

In one embodiment of the first aspect, the deflection is caused by the establishment of a magnetic field about the ion detection alteration means.

In one embodiment of the first aspect, the sample analysis apparatus comprises a contaminant flow direction alteration means configured to alter the direction of a contaminant with which an ion generated by the ion source is comingled, the alteration in direction being sufficient so as to separate the ion from the carrier gas stream.

In one embodiment of the first aspect, the contaminant flow direction alteration means forms a barrier or partial barrier to the passage of a contaminant.

In one embodiment of the first aspect, the barrier or partial barrier is positioned between the ion source and the detector, and the barrier or partial barrier is configured to allow passage of an ion generated by the ion source but prevent or inhibit the passage of a contaminant.

In one embodiment of the first aspect, the barrier or partial barrier acts to deflect a contaminant away from the ion detector input.

In one embodiment of the first aspect, the barrier or partial barrier comprises a discontinuity configured to allow passage of an ion generated by the ion source but prevent or inhibit the passage of a contaminant.

In one embodiment of the first aspect, the barrier or partial barrier is substantially dedicated to the purpose of allowing passage of an ion generated by the ion source but preventing or inhibiting the passage of a contaminant.

In one embodiment of the first aspect, the sample analysis apparatus comprises at least 2, 3, or more barriers or partial barriers, each of the barriers or partial barriers being in at least a partially overlapping or stacked arrangement.

In one embodiment of the first aspect, the detector is configured or positioned or orientated such that an ion generated by the ion source and conveyed along a substantially linear path from the ion source requires deviation from its linear path in order to enter the detector input.

In one embodiment of the first aspect, the detector is configured or positioned or orientated such that no line of sight is established between the ion source and the detector input.

In one embodiment of the first aspect, the detector is configured or positioned or orientated such that no line of sight is established between an origin of the sample carrier gas stream and the detector input.

In one embodiment of the first aspect, the detector input faces generally away from the ion source, or does not face generally toward the ion source.

In one embodiment of the first aspect, the sample analysis comprises: a vacuum chamber which encloses the ion source and the detector, the vacuum chamber having a chamber outlet port in gaseous communication with a vacuum pump so as to allow a vacuum to be established in the vacuum chamber, wherein the chamber outlet port is configured or positioned or oriented such that when the vacuum pump is in operation a contaminant comingling with an ion generated by the ion source and flowing in the same general direction as the ion, partitions into the chamber outlet port in preference to the detector.

In one embodiment of the first aspect, a barrier or partial barrier extends between the chamber outlet port and the detector input.

In one embodiment of the first aspect, the detector is at least partially enclosed so as to prevent or inhibit a contaminant from contacting an electron emissive surface or an electron collector/anode surface of the detector.

In one embodiment of the first aspect, the detector has one or more associated shields configured to deflect a sample carrier gas stream away from the detector input.

In one embodiment of the first aspect, the sample analysis apparatus comprises a sample inlet port through which a sample carrier gas and sample pass, the sample inlet port configured to direct a stream of sample carrier gas and sample toward the ion generator.

### BRIEF DESCRIPTION OF THE DRAWINGS

FIG. 1 is a highly schematic block diagram showing a typical prior art arrangement whereby a gas chromatography instrument is coupled to a mass spectrometer.

FIG. 2 is a highly schematic block diagram showing a preferred sample analysis apparatus reliant at least in part on the optics of the apparatus and the positioning of the detector input to inhibit the entry of residual sample carrier gas into the detector.

FIG. 3 and FIG. 4 are highly schematic block diagrams, each showing a preferred sample analysis apparatus reliant at least in part on the presence of a shield to inhibit the entry of residual sample carrier gas into the detector

FIG. 5 is a highly schematic block diagram showing a preferred sample analysis apparatus reliant at least in part on the presence of an enclosure about the detector to inhibit the entry of residual sample carrier gas into the detector.

FIG. 6 and FIG. 7 are a highly schematic block diagrams, each showing a preferred sample analysis apparatus reliant at least in part on the presence of multiple shields in overlapping arrangement to inhibit the entry of residual sample carrier gas into the detector.

FIG. 8 is a highly schematic block diagram showing a preferred sample analysis apparatus reliant at least in part on the presence of lenses configured to focus the ion stream so as to pass through a restricted aperture in a shield.

FIG. 9 and FIG. 10 are highly schematic block diagrams, each showing a preferred sample analysis apparatus reliant at least in part on the use of reflectrons configured to divert an ion stream about a shield.

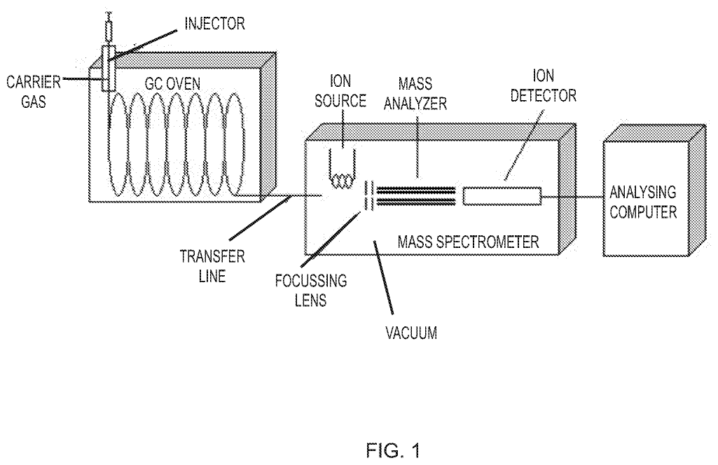

### DETAILED DESCRIPTION OF THE INVENTION INCLUDING PREFERRED EMBODIMENTS THEREOF

After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects apply to specific exemplary embodiments, and not necessarily to all embodiments covered by the claims.

Throughout the description and the claims of this specification the word “comprise” and variations of the word, such as “comprising” and “comprises” is not intended to exclude other additives, components, integers or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

It will be appreciated that not all embodiments of the invention described herein have all of the advantages disclosed herein. Some embodiments may have a single advantage, while other may have no advantage at all and are merely a useful alternative to the prior art.

The present invention is predicated at least in part on the discovery that contaminants which comingle with the ions emitted by the ion detector of a mass spectrometer may be carried along with the ions toward the detector. The contaminants may enter the detector (via the ion input, or any other route) and contact the electron emissive surfaces (such as a dynode) and/or the electron collector/anode surface so as to negatively affect performance and/or service life of the detector.

Upon recognition of that problem, Applicant has discovered that detector performance and/or service life is improved by configuring the sample analysis apparatus so as to allow the ions emitted from the ion source to travel to the detector by way of a separate path to that of contaminant (such as a residual carrier gas) flowing within the apparatus. In this way, the interior of a detector may be exposed to lower amounts of contaminant and without a substantial negative effect on the number of ions entering the detector. As will be demonstrated elsewhere herein, this result may be achieved in a number of ways including a rearrangement of components within the apparatus, the addition of various shields providing a barrier or partial barrier to a contaminant flow, and the use of reflectrons and lenses to selectively guide ions toward the detector. This approach is a significant departure from the prior art which has had no regard for the need to prevent or inhibit the entry of contaminants associated with an ion beam into the detector.

In the context of the present invention, the contaminant may be a residual sample carrier gas and/or a species carried by the residual sample carrier gas. As will be appreciated, a carrier gas such as helium, hydrogen or nitrogen is used in a mass spectrometer to convey an analyte. In the context of gas chromatography mass spectrometry the carrier gas acts to move the analyte through the chromatography medium. After exiting the medium the combination carrier gas and isolated analyte species are injected into the vacuum chamber of the mass spectrometer, thereafter being ionized by the ion source. From the ion source, the ions are accelerated into a mass analyser for separation on the basis of mass to charge ratio. Ions exiting the mass analyser are detected by a particle detector. Applicant has found that residual carrier gas (and any associated further contaminants) which travels along substantially the same line as the ions generated by the ion source to the detector, is capable of entering the detector to adversely affect detector life and/or performance.

In the context of the invention, the contaminant may be any atomic, subatomic, or molecular species, or any composite of species capable of adversely affecting the performance and/or service life of a particle detector. A contaminant may be, for example, a non-target peptide originating from the user (e.g. keratin from hair and skin), or may derive from reagents that are required to prepare samples for analysis such as an enzyme. Other laboratory reagents such as detergents may be introduced into the apparatus as contaminants. Such contaminants are introduced into the vacuum chamber of the mass spectrometer because they are a component of the injected sample.

The contaminant may be an impurity inherent in a carrier gas supplied to the apparatus. While great care is typically taken to ensure the purity of carrier gases, even trace levels of contaminant can, over repeated cycles of analysis, adversely affect a detector.

The contaminant may be a species that has desorbed from a chromatography medium through which the sample has passed.

Alternatively, the contaminant may be present in the vacuum chamber even before injection of sample. In that regard it is known that oils used in vacuum pumps can contribute to the contaminant load of a mass spectrometer. Such oils may deposit within the vacuum chamber at the end of an analysis, and enter a carrier gas stream established in the next analysis.

Applicant has found in particular, that configuring the sample analysis apparatus such that the detector input region does not directly “see” the ion source allows for ion and contaminant to be physically separated so as to improve performance and/or detector life by minimising the amount of a contaminant that enters the detector. As already discussed, contaminants often travel toward the detector input together with ions destined to enter the detector. By disrupting the line of sight between the ion source and the detector it is possible to provide some selectivity in allowing ions to enter the detector, while preventing or inhibiting the entry of contaminants.

In other forms of the invention the line of sight is maintained in so far as the ion beam is allowed to travel in a linear path from the ion source to the detector input, however a stream of contaminant flowing through the apparatus and comingling with the ions is diverted so as to avoid the detector input.

As will be appreciated, the vacuum within the vacuum chamber of the apparatus is established and maintained by a vacuum pump connected to port of the chamber. In some embodiments of the invention the vacuum pump is exploited as a means of rapidly sequestering contaminants away from the detector and detector input.

In addition or as an alternative to the mechanism described above, detector performance and/or life may be improved because such arrangements may inhibit or prevent internal ion feedback. The present invention, in some embodiments, results in lower amounts of neutral species inside the detector, and in such circumstances there is less material to be positively ionised by collisional ionisation (i.e. collisions with electrons inside the detector).

The drawings provide a number of non-limiting and exemplary embodiments which will form the basis of further description of the invention.

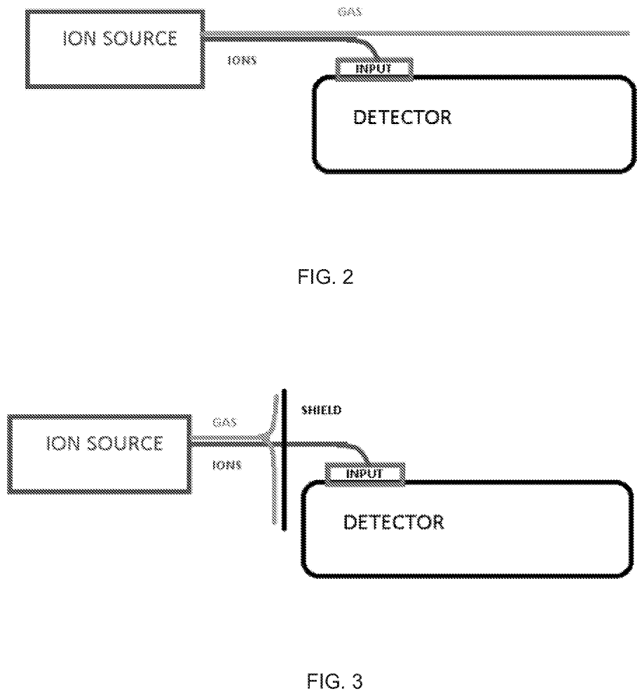

Turning firstly to FIG. 2, this embodiment does not require any physical structures dedicated to separating comingled ions from contaminants, such as the various shields and enclosures shown in other drawings. Instead, a combination of one or more electric and magnetic fields are used to divert ions away from the flow of residual sample carrier gas (being a contaminant in itself) and toward the detector input. The neutral particles of the residual sample carrier gas are unaffected by the electro-magnetic fields, and continue along their generally linear paths. The detector input is positioned such that the neutral particles travel past it, and typically toward an end region of the vacuum chamber where the vacuum pump port is disposed.

As will be appreciated, a prior art mass spectrometer may comprise a magnet for the purpose of separating particles on the basis of mass to charge ratio. However, magnetic fields established in prior art apparatus are not used for this purpose, and not in any arrangement with the detector and ion source as shown in FIG. 2.

A foreshadowed supra, the introduction of a barrier or partial barrier such as a shield into or about the path of an ion and/or contaminant may be used to separate an ion destined to enter a detector from a contaminant comingled therewith.

Reference is made to FIG. 3 showing an apparatus similar that of FIG. 2, but having a gas-impermeable shield disposed between the ion source and the detector. The shield has an aperture (not shown) dimensioned so as to just allow passage of the ion beam. As shown in the drawing, residual sample carrier gas flowing with the ions is deflected along the face of the shield, and therefore interrupted its path toward the detector. Thus, while a portion of the sample carrier gas may enter the aperture and travel toward the detector input, another portion will be prevented from doing so by the shield. Accordingly, the amount of sample carrier gas capable of entering the detector is decreased and therefore less fouling of the electron emissive and electron collector/anode surfaces of the detector is proposed.

In the embodiment of FIG. 3, the shield is not extensive and it is possible that some residual carrier gas will traverse about the edges and migrate toward the detector input. In that case, a direct flow of the gas into the detector input is nevertheless prevented. Furthermore, gas may flow about the detector and still bypass the detector input and eventually be removed from the chamber by the vacuum pump.

A shield such as that shown in FIG. 3 may be used where the detector input directly faces the ion source, and a line of sight established between the ion source and detector by way of an aperture in the shield. However, it is preferable to orientate the detector input away from the ion source so as to minimise entry of contaminants into the detector as far as possible.

The shields may be fabricated from any material deemed suitable by the skilled artisan having had the benefit of the present specification. Preferably, the material is one that does not contribute to “virtual leak” in that the material does not substantially desorb a liquid, a vapour or a gas into the chamber under vacuum. Such materials are often termed in the art “vacuum safe”. Desorbed substances can have detrimental effects on a vacuum pumping system of an instrument. Exemplary materials include ceramic and vitreous materials.

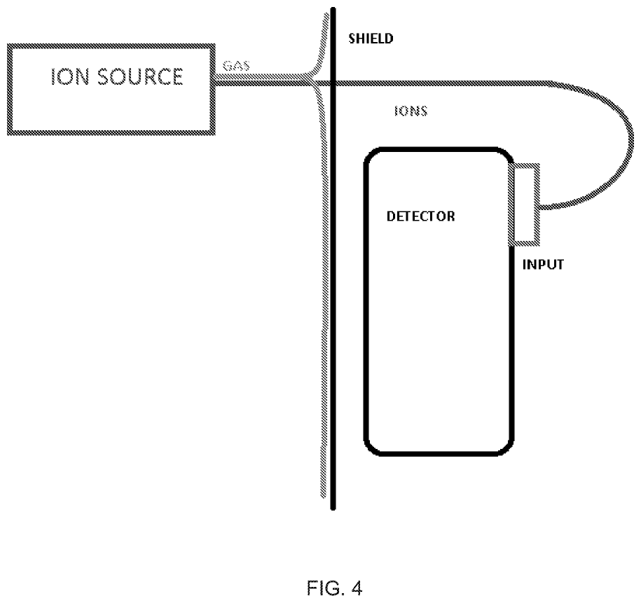

The shield may be more extensive, as shown in FIG. 4. In this embodiment the lower portion of the shield extends downwardly and to a point beneath that of the lower edge of the detector. This arrangement provides an incremental improvement in the inhibition of movement of residual carrier gas to the detector. As will be appreciated, detectors are typically not enclosed, with gas about the detector being capable of flowing into the internal regions thereof to contact an electron emissive surface or an electron collector/anode surface. Extending the shield beyond the lower edge of the detectors lessens that possibility.

In some embodiments, the shield may extend sufficiently so as to contact or nearly contact a wall of the chamber in which it is disposed.

In any event, it is preferable that the shield is not so extensive such that it slows the process of establishing or releasing a vacuum in the chamber. Gas may still be allowed to pass around the shield without significant interference.

In the embodiment of FIG. 4, the detector input is opposite facing to the ion source, with electro-magnetic fields used to reverse the direction of ion travel. Thus, even where residual sample carrier gas flows past the shield, the gas flow would need to reverse direction in order to enter the detector input.

An embodiment such as that shown in FIG. 4 but devoid of the shield would nevertheless inhibit the direct flow of gas into the detector input given the opposite orientation of the detector input and provide some advantage over an apparatus where the detector input is not orientated away from the ion source.

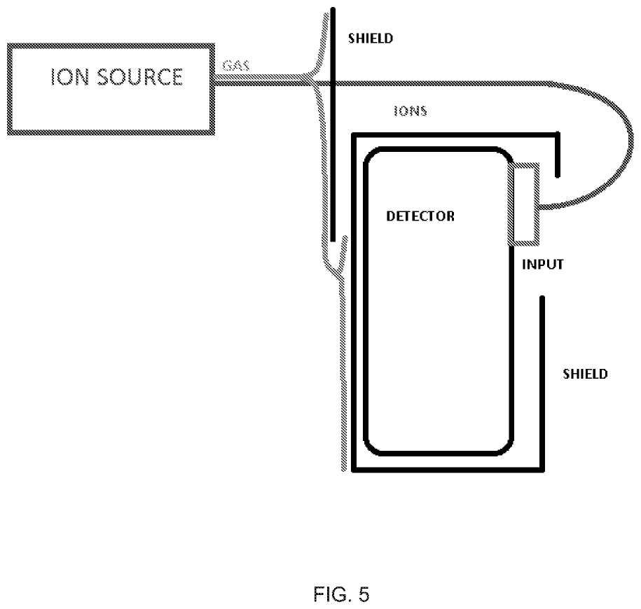

Turning now to the embodiment of FIG. 5, a relatively short shield is used in combination with a second shield forming an enclosure about the detector. The enclosure encircles the detector (but is not necessarily connected to the detector) so as to inhibit the entry of the residual carrier gas to the internal regions of the detector via the sides or ends of the detector.

It is to be understood that the enclosures depicted in the preferred embodiments of the drawings may or may not enclose the detector in a three-dimensional sense. For example an enclosure that sufficiently extends into and out of the page, may still be entirely operable and may lose very little effectiveness by not being close off at the ends. However, where an enclosure is just large enough to enclose the detector, it is more important to close off the ends so as to form a full enclosure in a three-dimensional sense.

As is shown in FIG. 5, the enclosure comprises an aperture to allow ions to enter the detector. The aperture will undoubtedly admit some residual carrier gas, however the majority is likely to be carried away from the detector environs by the vacuum pump connected to the vacuum chamber during operation of the sample analysis apparatus.

Advantage may be realised even where the first shield is dispensed with, and only the second shield about the detector is used. In that case, the flow of gas would need to reverse to enter the detector enclosure aperture, and the entry of gas into the detector via the sides and end of the detector will be inhibited.

As drawn in FIG. 5, a gap is shown between the shield and the detector. This gap is shown to emphasise graphically that the shields and enclosures of the present invention are not necessarily attached to the detector. Indeed, it is not essential to the invention that any shield is proximal to the detector. In some forms, the present invention the shields function mainly so as to inhibit a stream of contaminants from the ion source reaching the detector. For example a shield may be placed proximal to the ion source and distal to the detector. Generally, the shield is effective so long as it inhibits the ion source specific contaminants from reaching the detector, with that effect being achievable whether the shield is proximal to the ion source or the detector or indeed mid-way between.

The detector enclosure may be fabricated from “vacuum safe” materials as for the shields.

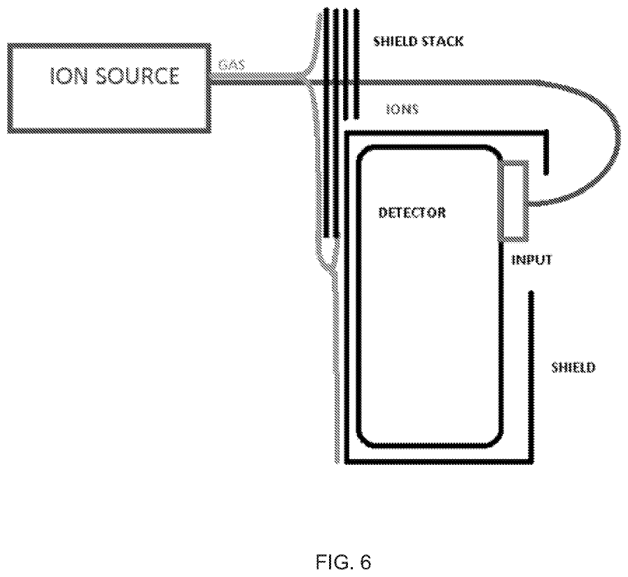

The embodiment of FIG. 6 shows the use of multiple stacked shields in combination with a shield forming an enclosure about the detector. The spaces formed between the stacked shields act to trap residual contaminant gas that migrates over the edges of the stack. At least some of the gas may remain trapped until the sample analysis is complete and the vacuum chamber purged. In this way, the stacked plates act as a transient reservoir of sorts for contaminant.

As will be appreciated, each of the stacked shields comprises an aperture of just sufficient size so as to pass the ion beam, each of the apertures in register so as to allow the ion beam to pass through all of the shields. Further potential advantage may be realised by each successive shield functioning so as to sequentially remove a proportion of gas that has passed through the aperture of the previous shield in the stack.

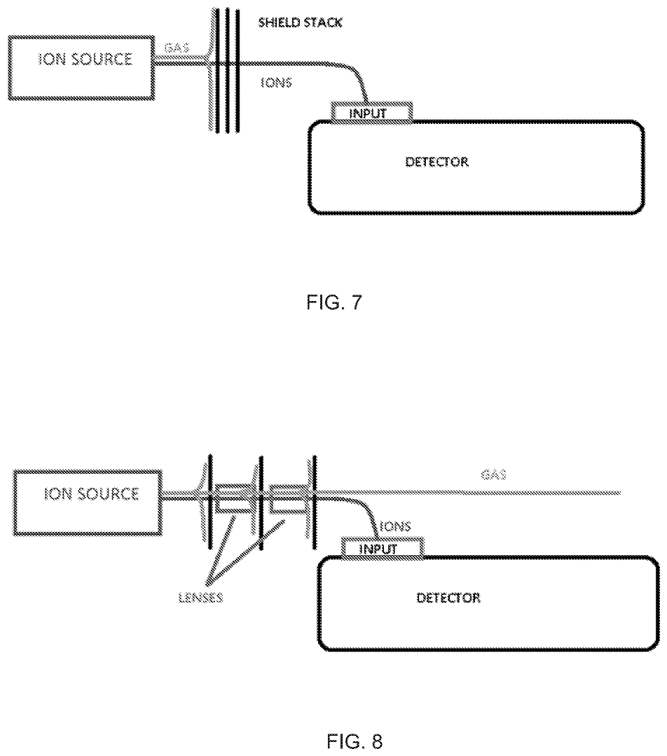

In the embodiment of FIG. 6, the stacked shields are shown in combination with a further shield encircling the detector. It will be appreciated that advantage may be realised where stacked shields are used solus, and without any shield about the detector. An exemplary embodiment in that regard is shown in FIG. 7.

Turning now to the embodiment of FIG. 8, an arrangement is shown whereby a series of three shields (each with an aperture in register), with interposed lenses provided. As will be immediately appreciated, these are not optical lenses but instead electro-magnetic lenses capable of focussing the ion beam by deflecting particles close to the centre less strongly than those passing the lens distal from the axis. This approach allows for the use of progressively smaller apertures in the second and third shields respectively given that a focussed ion beam will have a small diameter than the input beam. Of course, residual sample carrier gas will not be focussed by the lenses and will therefore collide with the region of the shield peripheral to the aperture.

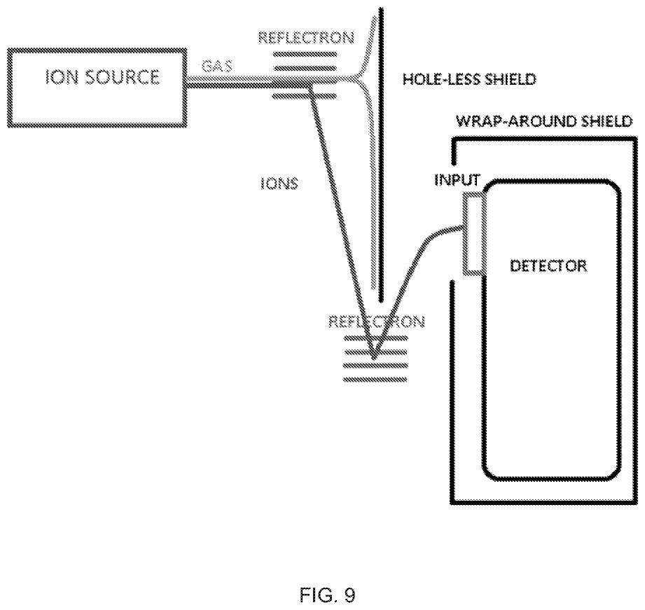

In some embodiments, means for diverting the ion beam such that the beam travels to the detector input by an indirect path is used. In these embodiments, the diversion maintains the beam linearity but alters the direction of the beam. The embodiment of FIG. 9 shows such an arrangement whereby an ion beam reflection means (specifically reflectrons) are used to force the ion beam along an indirect path toward the detector input. These embodiments are different therefore to embodiments where the diversion results in a curved beam (for example, the embodiment of FIG. 2). As will be appreciated, the reflectrons have no effect on the path of the residual sample carrier gas which is comingled with the ions in the beam, this leading to a separation of the gas from the ions.

The use of one or more reflectrons may provide advantage without any shield. However, the preferred embodiment of FIG. 9 shows a shield which may provide a superior result (i.e. exclusion of carrier gas from the detector) as compared with the case where no shield is provided. The shield in FIG. 9 has no aperture, and accordingly all residual sample carrier gas which collides with it is deflected as shown in the drawing. To overcome the lack of an aperture, the ion beam is diverted about the shield by the use of a first reflectron to divert the beam to a point inferior to the lower edge of the shield, and a second reflectron to divert the ion beam toward the detector input.

The embodiment of FIG. 9 shows also the use of a shield to enclose the detector, albeit leaving an aperture to allow entry of ions into the detector input. The shield is optional, although may provide advantage when combined with either or both the use of reflectron(s) and the use of a shield.

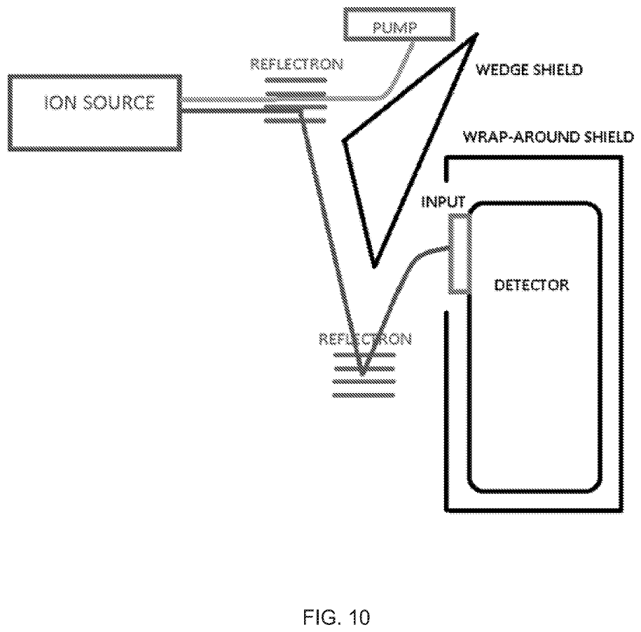

The embodiment of FIG. 10 is similar to that of FIG. 9 with the exception that a wedge-shaped shield is placed in the path of the sample carrier gas so as to deflect the gas away from the detector. Optionally, the wedge-shaped shield may be configured to deflect gas toward the port in the chamber directed to the vacuum pump leading to the net removal of carrier gas from the chamber.

A shield that functions to divert carrier gas toward the vacuum pump may be used in any embodiment of the apparatus so as to facilitate the physical removal of any contaminant separated from the ions. In this way, the contaminant is not able to enter the detector at any later time.

Applicant proposes that the various arrangement of components (i.e. ion source, detector, vacuum pump, magnet, and any shields, lenses or reflectrons), and the inclusion of novel structures (such as shields, lenses and reflectrons) may be incorporated into the design of existing ample analysis apparatus, or alternatively as the bases for de novo design of such apparatus.

It is to be understood that any strategy for separating comingled ion and contaminants according to the present invention may be used alone, or in combination with any one or more other strategy. With regard to strategies, the following are listed:
1. relative spatial arrangement of ion source and/or detector and/or electro-magnetic field and/or vacuum pump port
2. orientation of detector input
3. orientation of detector input in relation to ion source
4. use of barrier or partial barrier disposed between the ion source and detector input
5. use of stacked or overlapping barriers or partial barriers between the ion source and detector input
6. use of barrier or partial barrier having an aperture between the ion source and detector input
7. use of barrier or partial barrier having no aperture between the ion source and detector input
8. use of barrier or partial barrier about the detector
9. use of stacked or overlapping barriers or partial barrier about the detector
10. use of barrier or partial barrier having an aperture about the detector
11. use of barrier or partial barrier having no aperture about the detector
12. use of lenses to focus the ion beam
13. use of lenses in combination with a barrier or partial barrier having an aperture
14. use of ion beam reflective means
15. use of ion beam reflective means with a shield, the reflective means configured to direct an ion beam about a barrier or partial barrier
16. use of a barrier or partial barrier to deflect a flowing contaminate away from the detector
17. use of a vacuum pump to partition a flowing contaminant away from the detector, and optionally rapidly sequester the contaminant external to the vacuum chamber
18. use of a vacuum pump to partition a deflected contaminant away from the detector, and optionally rapidly sequester the contaminant external to the vacuum chamber

With regard to the 18 strategies defined above, it will be appreciated that 18! (i.e. 6.4×10¹⁵) combination strategies are defined in this specification. Each of the individual combinations are to be considered a discrete embodiment of the invention.

In some embodiments of the sample analysis apparatus, the detector is itself configured to exclude contaminants such as sample carrier gas. The detector acts additionally or synergistically with the various component arrangements, shields, reflectrons, and lenses to even further reduce the level of contaminant fouling the electron emissive surfaces and electron collector/anode surfaces of the detector. In that regard, the particle detector may be configured such that the environment about the electron emissive surface(s) and/or the electron collector/anode surface is/are different to the environment immediately external to the enclosure.

In one embodiment, the particle detector is configured so as to allow for user control of the environment about the electron emissive surface(s) and/or the electron collector/anode surface such that the environment about the electron emissive surface(s) is different to the environment immediately external to the enclosure.

In one embodiment of the sample analysis apparatus, the particle detector comprises means for establishing an environment about the electron emissive surface(s) and/or the electron collector/anode surface which is different to the environment immediately external to the enclosure.

In one embodiment of the sample analysis apparatus, the particle detector comprises means for user control of the environment about the electron emissive surface(s) and/or the electron collector/anode surface such that the environment about the electron emissive surface(s) is different to the environment immediately external to the enclosure.

In one embodiment of the sample analysis apparatus, the environment about the electron emissive surface(s) and/or the electron collector/anode surface is different to the environment immediately external to the enclosure with regard to: the presence, absence or partial pressure of a gas species in the respective environments; and/or the presence, absence or concentration of a contaminant species in the respective environments.

In one embodiment of the sample analysis apparatus, the particle detector is configured to increase or decrease a vacuum conductance thereof compared with a similar or otherwise identical particle detector of the prior art that is not so configured.

In one embodiment of the sample analysis apparatus, the particle detector is configured to allow for user control of a vacuum conductance of the particle detector.

In one embodiment of the sample analysis apparatus, the particle detector is configured to operate such that a gas flowing external to internal the particle detector and/or from internal to external the particle detector does not have the flow characteristics of a conventional fluid.

In one embodiment of the sample analysis apparatus, the particle detector is configured to operate such that a gas flowing external to internal the particle detector and/or from internal to external the particle detector has the flow characteristics of molecular flow.

In one embodiment of the sample analysis apparatus, the particle detector is configured to operate such that a gas flowing external to internal the particle detector and/or from internal to external the particle detector has flow characteristics transitional between conventional fluid flow and molecular flow.

In one embodiment of the sample analysis apparatus, the particle detector is configured to, or comprising means for lowering the pressure internal the particle detector.

In one embodiment of the sample analysis apparatus, the particle detector is configured to, or comprises means for, lowering the gas pressure internal the particle detector sufficient to alter the flow characteristics of the gas flowing external to internal the particle detector and/or from internal to external the particle detector.

In one embodiment of the sample analysis apparatus, the particle detector comprises a series of electron emissive surfaces arranged to form an electron multiplier.

In one embodiment of the sample analysis apparatus, the enclosure is formed from about 3 or less enclosure portions, or about 2 or less enclosure portions.

In one embodiment of the sample analysis apparatus, the enclosure is formed from a single piece of material.

In one embodiment of the sample analysis apparatus, the enclosure comprises one or more discontinuities.

In one embodiment of the sample analysis apparatus, the particle detector, comprises means for interrupting a flow of a gas external the particle detector into one or all of the one or more discontinuities.

In one embodiment of the sample analysis apparatus, at least one of the one or more discontinuities, or all of the one or more discontinuities, is/are dimensioned so as to limit or prevent entry of a gas external the particle detector into the particle detector.

In one embodiment of the sample analysis apparatus, at least one of the one or more discontinuities, or all of the one or more discontinuities, is/are no larger than is required for its/their function(s).

In one embodiment of the sample analysis apparatus, at least one of the one or more discontinuities, or all of the one or more discontinuities, is/are positioned on the enclosure and/or orientated with respect to the particle detector so as to limit or prevent entry of a gas external the particle detector into the particle detector.

In one embodiment of the sample analysis apparatus, at least one of the one or more discontinuities, or all of the one or more discontinuities has a gas flow barrier associated therewith.

In one embodiment of the sample analysis apparatus, at least one of the gas flow barriers, or all of the gas flow barriers, is/are configured so as to limit or prevent the linear entry of a gas external the particle detector into the particle detector.

In one embodiment of the sample analysis apparatus, at least one of the gas flow barriers, or all of the gas flow barriers, comprise one or more walls extending outwardly from the periphery of the discontinuity.

In one embodiment of the sample analysis apparatus, at least one of the gas flow barriers, or all of the gas flow barriers is/are elongate and/or slender.

In one embodiment of the sample analysis apparatus, at least one of the gas flow barriers, or all of the gas flow barriers, comprise(s) one or more bends and//or one or more 90 degree bends,

In one embodiment of the sample analysis apparatus, at least one of the gas flow barriers, or all of the gas flow barriers, comprise(s) a baffle

In one embodiment of the sample analysis apparatus, the at least one of the gas flow barriers, or all of the gas flow barriers, is/are formed as a tube having an opening distal to the discontinuity.

In one embodiment of the sample analysis apparatus, the opening distal to the discontinuity is positioned on the tube and/or orientated with respect to the particle detector so as to limit or prevent entry of a gas external the particle detector into the particle detector.

In one embodiment of the sample analysis apparatus, at least one of the gas flow barriers, or all of the gas flow barriers is/are curved and/or devoid of corners on an external surface thereon.

In one embodiment of the sample analysis apparatus, wherein the external surface of the enclosure is curved, or comprises a curve, and/or is devoid of a corner.

In one embodiment of the sample analysis apparatus, the particle detector comprises an internal baffle.

In one embodiment of the sample analysis apparatus, the internal baffle interrupts a line of sight through the particle detector.

In one embodiment of the sample analysis apparatus, the particle detector comprises an input aperture, wherein the input aperture has a cross-sectional area less than about 0.1 cm².

In one embodiment of the sample analysis apparatus, the particle detector is configured such that no line of sight through the particle detector exists.

While the present invention has been described primarily by reference to a detector of the type used in a mass spectrometer, it is to be appreciated that the invention is not so limited. In other applications the particle to be detected may not be an ion, and may be a neutral atom, a neutral molecule, or an electron. In any event, a detector surface is still provided upon which the particles impact.

The detector of the present sample analysis apparatus may be any type of detector that is used in the art to detect a particle. The detector will typically be configured to amplify an ion signal by way of secondary electron emission. Potentially suitable detectors include those based on discrete dynode electron multiplication, continuous electron multiplication and micro channel plate multiplication.

It will be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. Functionality may be added or deleted from the diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

1. A sample analysis apparatus comprising:
an ion source configured to generate an ion from a sample input into the particle detection apparatus, and
an ion detector having an input configured to receive an ion generated from an ion source,
wherein the sample analysis apparatus is configured such that a contaminant comingling with an ion generated by the ion source and flowing in the same general direction as the ion, is inhibited or prevented from entering the detector input.

2. The sample analysis apparatus of claim 1, comprising ion direction alteration means configured to alter the direction of an ion generated by the ion source and conveyed in a direction away from the ion source, the alteration in direction being sufficient so as to separate the ion from the contaminant or at least decrease the concentration of the contaminant in a space about the ion.

3. The sample analysis apparatus of claim 2, wherein the ion direction alteration means acts to deflect the path of an ion generated by the ion source and conveyed in a direction away from the ion source.

4. The sample analysis apparatus of claim 3, wherein the deflection is caused by the establishment of an electro-magnetic field about the ion detection alteration means.

5. The sample analysis apparatus of claim 1, comprising a contaminant flow direction alteration means configured to alter the direction of a contaminant with which an ion generated by the ion source is comingled, the alteration in direction being sufficient so as to separate the ion from the carrier gas stream.

6. The sample analysis apparatus of claim 5, wherein the contaminant flow direction alteration means forms a barrier or partial barrier to the passage of a contaminant.

7. The sample analysis apparatus of claim 6, wherein the barrier or partial barrier is positioned between the ion source and the detector, and the barrier or partial barrier is configured to allow passage of an ion generated by the ion source but prevent or inhibit the passage of a contaminant.

8. The sample analysis apparatus of claim 6, wherein the barrier or partial barrier acts to deflect a contaminant away from the ion detector input.

9. sample analysis apparatus of claim 6, wherein the barrier or partial barrier comprises a discontinuity configured to allow passage of an ion generated by the ion source but prevent or inhibit the passage of a contaminant.

10. The sample analysis apparatus of claim 6, wherein the barrier or partial barrier is substantially dedicated to the purpose of allowing passage of an ion generated by the ion source but preventing or inhibiting the passage of a contaminant.

11. The sample analysis apparatus of claim 6, comprising at least two barriers or partial barrier, each of the barriers or partial barrier being in at least a partially overlapping or stacked arrangement.

12. The sample analysis apparatus of claim 1, wherein the detector is configured or positioned or orientated such that an ion generated by the ion source and conveyed along a substantially linear path from the ion source requires deviation from its linear path in order to enter the detector input.

13. The sample analysis apparatus of claim 1, wherein the detector is configured or positioned or orientated such that no line of sight is established between the ion source and the detector input.

14. The sample analysis apparatus of claim 1, wherein the detector is configured or positioned or orientated such that no line of sight is established between an origin of the sample carrier gas stream and the detector input.

15. The sample analysis apparatus of claim 1, wherein the detector input faces generally away from the ion source, or does not face generally toward the ion source.

16. The sample analysis apparatus of claim 1 comprising: a vacuum chamber which encloses the ion source and the detector, the vacuum chamber having a chamber outlet port in gaseous communication with a vacuum pump so as to allow a vacuum to be established in the vacuum chamber, wherein the chamber outlet port is configured or positioned or oriented such that when the vacuum pump is in operation a contaminant comingling with an ion generated by the ion source and flowing in the same general direction as the ion, partitions into the chamber outlet port in preference to the detector.

17. The sample analysis apparatus of claim 16, wherein a barrier or partial barrier extends between the chamber outlet port and the detector input.

18. The sample analysis apparatus of claim 1, wherein the detector is at least partially enclosed so as to prevent or inhibit a contaminant from contacting an electron emissive surface or an electron collector/anode surface of the detector.

19. The sample analysis apparatus of claim 1, wherein the detector has one or more associated shields configured to deflect a sample carrier gas stream away from the detector input.

20. The sample analysis apparatus of claim 1, comprising a sample inlet port through which a sample carrier gas and sample pass, the sample inlet port configured to direct a stream of sample carrier gas and sample toward the ion generator.
